(19) United States
(12) Patent Application Publication
(10) Pub. No.: US 2004/0084791 A1
(43) Pub. Date: May 6, 2004

(54) Biodegradale polyurethane capsules and manufacturing method thereof

(76) Inventors: Kyu-Tek Han, Seongbuk-gu (KR); Jung-Hoon Choi, Jongo-gu (KR); In-Gyu Lee, Kyunggi-do (KR); lk-Soo Chung, Daejeon (KR)

Correspondence Address: INTELLECTUAL PROPERTY GROUP, FREDRIKSON & BYRON, P.A., 4000 PILLSBURY CENTER, 200 SOUTH SIXTH STREET, MINNEAPOLIS, MN, 55402, US

(21) Appl. No.: 10/466,800

(22) PCT Filed: Jan. 17, 2002
(86) PCT No.: PCT/KR02/00078

(30) Foreign Application Priority Data
Jan. 18, 2001 (KR) 20012993
Oct. 25, 2001 (KR) 200166086

(51) Int. Cl. B32B 5/16

(52) U.S. Cl. 264/4.32; 428/402.24; 428/407; 264/4.33; 521/56

(57) ABSTRACT

The present invention relates to biodegradable polyurethane capsules for molded product of polyurethane foam and to methods for manufacturing the same, the inventive biodegradable polyurethane capsule comprises a powder made from a biodegradable material, first coating layer of calcium alginate gel formed on the surface of said power and second coating layer of foamable polyurethane resin formed on the surface of said first coating layer. Products manufactured from the biodegradable polyurethane capsule according to the present invention can be widely used as heat isolating materials and heat isolating structural materials because the basic physical properties such as heat insulation are good. And, since the biodegradable material inside the capsule is decomposed by microbes in the nature after a certain period, the efficiency of destruction is considerably improved, so it is possible to minimize the conventional problems of soil, air, and sea pollution caused by fill-in or incineration of the wastes of polyurethane molded foam product.

### BACKGROUND OF THE INVENTION

(a) Field of the Invention

The present invention relates to biodegradable polyurethane capsules for molding product of polyurethane foam and to manufacturing methods thereof. More particularly, it relates to biodegradable polyurethane capsules as materials for molded product of polyurethane foam, which can minimize the conventional problems of soil, air, and sea pollution caused by fill-in or incineration of wastes of molded foam product because the biodegradable material in the capsule is decomposed by microbes in the natural world after a certain period, so the efficiency of destruction is considerably improved, in addition, the physical properties such as impact-resistant property, anti-breakability, etc. of the inventive material are superior, and it also relates to manufacturing methods thereof.

(b) Description of the Related Art

Synthetic polymers represented by plastic are ones of the materials necessary for convenient and comfortable present-day life along with metals and ceramics. Such synthetic polymers are used for products of various industrial fields such as daily life material, construction, medical service, agriculture, etc. and the amount of use is considerably increasing. However, contrary to natural polymers, most of synthetic polymers are not easily decomposed, so the disposal and management of wastes of synthetic polymer products are big social problems for all the countries over the world.

Especially, the molding products of polyurethane foam can be obtained by molding after preparing the polyurethane foam by reacting polyol with isocyanate in the presence of blowing agents such as CFC, reaction catalyst, and stabilizing agent of the foam, which are widely used as heat isolating materials, heat isolating panels, and heat isolating structural materials of such as electric refrigerator, ship and vehicles. However, because the wastes of molding products of polyurethane foam are regulated as designated-waste by law, the restriction for treatment of them is fastidious. And their volume is large, so a vast area is required to bury the wastes. In addition, the soil is polluted by the same since such products are so slowly decomposed. And if the wastes of the same flow to the sea, and the sea can be polluted as a result. When the wastes are destructed by fire, many poisonous gases are emitted to pollute the air.

Accordingly, some countries such as U.S.A. or Italy had passed a bill to restrict the use of synthetic polymer products which have a short period of use and which require durability not so much, and to substitute degradable material for them.

As a part of researches for overcoming these problems of disposal of synthetic polymer products, many recycling methods of wastes of polyurethane foam products are proposed.

For example, the U.S. Pat. No. 5,451,376 discloses a mechanical method of recycling as filler for injecting molded or extruded products by cracking the Waste of polyurethane minutely, or recycling as re-adhesive foam by compressing after cracking into proper pieces. However, the polyurethane used as filler is foam and thermosetting polymer. Therefore, there is no interaction at the interface between the matrix resin used for preparing the molded products by injection or extrusion and the recycling polyurethane, so the molded products prepared by this method have the problem that the physical properties are remarkably deteriorated. And, the U.S. Pat. No. 5,451,376 discloses a chemically recycling method of depolymerization of polyurethane by using various solvents. According to this method, but the conversion ratio is low, so it is disadvantageous in economic point of view.

Further, a method focusing on the recovery of thermal energy by incinerating the same along with other municipal solid wastes rather than the recycling of polyurethane foam was also proposed. But, such methods of recycling the molded foam products have no economic efficiency because their cost is too high. In addition, the final wastes of the products should be disposed by the conventional methods such as burying in the end, and another environmental problems may occur during the recycling process.

### SUMMARY OF THE INVENTION

Accordingly, an object of the present invention is to overcome the above-mentioned problems and to provide biodegradable polyurethane capsules as materials for molded product of polyurethane foam, which can minimize the conventional problems of soil, air, and sea pollution caused by fill-in or incineration of wastes of molded foam product because the biodegradable material in the capsule is decomposed by microbes in the natural world after a certain period, in addition, the physical properties of the inventive material such as impact-resistant property, anti-breakability, etc. are superior.

Another object of the present invention is to provide methods for manufacturing a biodegradable polyurethane capsule.

To achieve the object mentioned above, the present invention provides a biodegradable polyurethane capsule comprising a powder made from the biodegradable material, first coating layer of calcium alginate gel formed on the surface of said powder and second coating layer of foamable polyurethane resin formed on the surface of said first coating layer.

According to the biodegradable polyurethane capsule of the present invention, the grain may be used for the degradable powder forming core part of the capsule, especially, it is preferable to use corn powder, foamed corn powder, rice powder, and foamed rice powder.

Further, to achieve the object mentioned above, the present invention provides a biodegradable polyurethane capsule comprising a capsule of calcium alginate gel containing carbon dioxide therein and a coating layer of foamable polyurethane resin formed on the surface of said capsule.

Further, to achieve the object mentioned above, the present invention provides a biodegradable polyurethane capsule comprising a powder made from the biodegradable material, a coating layer of calcium alginate gel formed on the surface of said powder and an outer layer composed of foamable polyurethane resin prepared by the addition polymerization of activated hydroxide group in calcium alginate gel with isocyanate, which is formed on the surface of said coating layer.

Further, to achieve the object mentioned above, the present invention provides a biodegradable polyurethane capsule comprising a capsule of calcium alginate gel containing carbon dioxide therein and an outer layer composed of foamable polyurethane resin prepared by the addition polymerization of activated hydroxide group in calcium alginate gel with isocyanate, which is formed on the surface of said capsule.

To achieve the another object mentioned above, the present invention provides a method for manufacturing the biodegradable polyurethane capsule comprising steps of a) forming a capsule having first coating layer of calcium alginate gel on the surface of the powder by dropping an aqueous solution of sodium alginate in which the powder made from the biodegradable material is dispersed into an aqueous solution of calcium chloride while agitating; b) separating and drying said capsule; and c) forming second coating layer of foamable polyurethane resin on the surface of said separated capsule.

According to the method of the present invention, the step c) of forming second coating layer of foamable polyurethane resin may comprise steps of inputting polyol and isocyanate into said separated capsule and reacting them in the presence of foaming agent and reaction catalyst. Or, it may also comprise steps of reacting with isocyanate in the presence of foaming agent and reaction catalyst after coating polyol on the surface of said separated capsule.

In addition, to achieve the another object mentioned above, the present invention provides a method for manufacturing the biodegradable polyurethane capsules comprising steps of a) forming a capsule of calcium alginate gel containing carbon dioxide therein by dropping an aqueous solution formed by mixing sodium alginate with sodium bicarbonate into an aqueous solution of calcium chloride while agitating; b) separating and drying said capsule; and c) forming a coating layer of foamable polyurethane resin on the surface of said separated capsule.

### DETAILED DESCRIPTION OF THE PREFERRED EMBODIMENTS

The detailed description about biodegradable polyurethane capsules and methods for manufacturing the same according to the present invention are provided hereinafter.

Degradable polymer is generally classified into biodegradable one, hydrolyzable one, photodegradable one, and oxidizable one according to the decomposition process. According to the definition of U.S.A. ASTM, biodegradable one is the polymer decomposed by the microbes such as bacteria, fungi, and algae and hydrolyzable one is the polymer decomposed by the hydrolysis. Further, photodegradable one is the polymer decomposed by natural light, especially ultraviolet rays and oxidizable one is the polymer decomposed by oxidation. On the other hand, Biodegradable Plastic Society of Japanese defines the biodegradable polymers as the polymers that could be decomposed into small molecules by the microbes in the nature not to be harmful to the environment.

Accordingly, for being a biodegradable polymer, the material should be completely decomposed into water and carbon dioxide by the microbes in the nature and be returned to the nature not to make environmental problems. However, the microbes have substrate-specific properties. That is, a microbe has high reactivity to the compounds of specific molecular structure. Accordingly, though a synthetic polymer is designed to be biodegradable, it may not be effectively decomposed by the microbes which exist in the nature. Therefore, the present invention provides biodegradable capsules that may easily be decomposed by the microbes in the nature by using natural powder such as corn powder or natural polymer, i.e. alginic acid obtained from plants for core part of the foamable polyurethane resin.

A biodegradable polyurethane capsule according to an embodiment of the present invention is comprises a powder made from the biodegradable material, first coating layer of calcium alginate gel formed on the surface of said powder and second coating layer of foamable polyurethane resin formed on the surface of said first coating layer.

Since the powder made from the biodegradable material and the calcium alginate gel are decomposed by microbes after a certain period, the coating layer of polyurethane resin formed on the surface thereof is destroyed. Accordingly, when the wastes of the products prepared by these biodegradable capsules are buried, their volume become remarkably smaller as time goes by, and the disposal efficiency of the wastes is considerably improved. For the biodegradable powder consisting the core part of a biodegradable capsule, all kinds of material may be used only if the same is biodegradable and the surface thereof may be coated with polyurethane resin. It is preferable to use inexpensive grain powder such as corn powder, foamed corn powder, rice powder, and foamed rice powder.

Alginic acid, material for manufacturing calcium alginate gel that forms the layer of the biodegradable capsule according to the present invention may be obtained from the brown algae of oceanic plants in a large amount. Alginic acid is a copolymer of straight chains of which the block of manuronic acid(M) unit, the block of gluronic acid(G) unit, and the block of MG unit, i.e. middle of M and G are composed with 1,4-glycoside and its molecular weight is 20,000-200,000 or so. Alginic acid forms a gel by reacting with metallic ions such as calcium, and the gel is not melted by heat, so heat treatment is possible. Especially, since soft gel can be prepared owing to the M block, the property of the gel can be changed in accordance with the ratio of M/G. If the encapsulation is accomplished by adding enzyme, microbe, animal cell, or plant cell in the course of gelation, the biodegradability could be regulated. As mentioned above, the coating layer of the calcium alginate gel formed on the surface of the biodegradable powder has great biodegradability and good elasticity, so it is possible to improve much more the physical properties of impact-resistance and anti-breakability.

In addition, according to an embodiment of present invention, for foamable polyurethane resin which is the raw material of second coating layer, various kinds of polyurethane resins that are known to the skilled in the art can be used if can be coated on the surface of the first coating layer. Especially, because the polyurethane resin has superior isolation property, it gives the isolation property to the molded products of polyurethane foam.

Referring to a manufacturing method of such biodegradable polyurethane capsules according to an embodiment of present invention above mentioned, first, a capsule having first coating layer of calcium alginate gel on the surface of powder is made by dropping the aqueous solution of sodium alginate in which powder formed of biodegradable material such as foamed corn powder is dispersed into an aqueous solution of calcium chloride while agitating. Here, the particle diameter of the capsule may be regulated according to the agitating speed. That is, when the agitating speed is high, the particle diameter is small, and when the agitating speed is low, the capsule has relatively large particle diameter. It is preferable to agitate at the speed of 50 to 150 rpm. Next, the capsule is filtered with a filter or a centrifugal machine and then dried. And, the second coating layer composed of foamable polyurethane on the surface of the capsule is formed by reacting in the presence of the foaming agent and the reaction catalyst after inputting polyol and isocyanate into the separated capsule, or by dropping isocyanate after forming a coating layer of polyol formed by the reaction of polyol with the separated capsule in the presence of the foaming agent and the reaction catalyst. Here, the foaming agent and the reaction catalyst are any of those commonly used for manufacturing the polyurethane foam. For example, for the foaming agent, a sort of chlorofluorocarbon (CFC-11, CFC-12, etc.), HCFC-123, HCFC-141b, HFC-134a, HFC-152a, a sort of hydrochlorofluorocarbon, a sort of hydrofluorocarbon, etc., may be used. And, for the catalyst, triethylamine, diethylethanolamine, potassium hydroxide, etc., may be used.

The biodegradable polyurethane capsule according to another embodiment of the present invention comprises a capsule made of calcium alginate gel containing carbon dioxide inside the capsule and a coating layer of foamable polyurethane resin formed on the surface of said capsule. Products made from such biodegradable capsules have great biodegradability as well as a superior impact-resistant property and elasticity since inside of the capsule is filled with gas.

A method for manufacturing the biodegradable polyurethane capsule according to another embodiment of the present invention above-mentioned is as follows.

An elastic capsule comprised of porous calcium alginate gel containing carbon dioxide inside it is formed by dropping an aqueous solution of mixture of sodium alginate and NaHCO₃ into an aqueous solution of calcium chloride while agitating. Here, the particle diameter of the capsule may be regulated according to the agitating speed. That is, if the agitating speed is high, the particle diameter is small and if the agitating speed is low, the capsule has relatively large particle diameter. After the capsule is filtered with a filter or a centrifugal machine and dried, the coating layer composed of foamable polyurethane on the surface of the capsule is formed by reacting in the presence of the foaming agent and the reaction catalyst after inputting polyol and isocyanate into the separated capsule, or by dropping isocyanate after forming a coating layer of polyol formed by the reaction of polyol with the separated capsule in the presence of the foaming agent and the reaction catalyst as described above.

Then, the products having desired shape and property can be manufactured by putting the biodegradable polyurethane capsules according to the present invention into a designated mold and then foaming the same while the foaming pressure controlled.

The biodegradable polyurethane capsule according to another embodiment of the present invention comprises a capsule formed on the surface of a powder made from the biodegradable material, or a capsule composed of calcium alginate gel containing carbon dioxide inside it, and an outer layer composed of foamable polyurethane resin prepared by the addition polymerization of activated hydroxide group of calcium alginate gel with isocyanate, which is formed on the surface of said coating layer.

The capsule composed of calcium alginate gel contains many activated hydroxide groups, so they react with isocyanate in the presence of reaction catalyst to form the outer layer composed of polyurethane by the addition polymerization on the surface of the capsule with isocyanate.

### EMBODIMENT

The detailed description of the present invention referring to the embodiments is provided hereinafter. However, the embodiments according to the present invention can be modified in various ways and should not be understood to be restricted to the embodiments described below. The embodiments of the present invention are provided to describe the present invention more clearly to a person who has standard knowledge in the art.

### MANUFACTURING EXAMPLE OF A COATING LAYER OF CALCIUM ALGINATE GEL

### Manufacturing Example 1

4.0 g of sodium alginate and 50.0 g of foamed corn powder are added into a mixed solution of 20.0 ml acetone and 80.0 ml water at room temperature and the mixture is agitated for an hour. Next, the mixture is dropped into a saturated calcium chloride solution of 60° C. while agitating at 100 rpm to obtain 150.0 g of the porous biodegradable capsule coated with the calcium alginate gel on the surface of the corn powder.

### Manufacturing Example 2

4.0 g of sodium alginate, 50.0 g of foamed corn powder, and 1 g of sodium bicarbonate are added into 100.0 ml of water at room temperature and the mixture is agitated for an hour. Next, the mixture is dropped into a saturated calcium chloride solution of 35° C. while agitating at 100 rpm to obtain 155.0 g of the porous biodegradable capsule coated with the calcium alginate gel on the surface of the corn powder.

### Manufacturing Example 3

4.0 g of sodium alginate and 1 g of sodium bicarbonate are added into 100.0 ml of water at room temperature and the mixture is agitated for an hour. Next, the mixture is dropped into a saturated calcium chloride solution of 30° C. while agitating at 100 rpm to obtain 100 g of the elastic capsule comprised of the calcium alginate gel containing carbon dioxide inside the capsule.

The physical properties of the capsules obtained according to the manufacturing examples 1 to 3 are measured and described in the following Table 1.

### A Method of Measuring the Physical Properties

Biodegradability: measured according to the guide of OECD 301,C,MITI TEST(II)(1992).

TABLE 1

| | | Thickness of coating | |
|---|---|---|---|
| | Average particle | layer of calcium | Biodegrad- |
| | diameter of capsule | alginate gel | ability |
| | (mm) | (mm) | (%) |
| Manufacturing | 2 | 0.008 | 97 |
| example 1 | | | |
| Manufacturing | 2 | 0.011 | 98 |
| example 2 | | | |
| Manufacturing | 2 | 0.010 | 99 |
| example 3 | | | |

Referring to Table 1, the capsules obtained according to the manufacturing examples 1 to 3 have a superior biodegradability and uniform thickness of coating layers.

### Embodiment 1

20.0 g of the porous capsule prepared by manufacturing example 1, 0.1 ml of triethylamine, 5.0 ml of ethyleneglycol and 10.0 ml of polyol are mixed and agitated for 30 minutes at room temperature. 5.0 ml of isocyanate is dropped to the mixture and the addition polymerization is performed to obtain 30.0 g of capsule coated with polyurethane on the surface of the porous capsule. The above result is put in a molding foam device, and is molded to manufacture a product of the biodegradable polyurethane foam.

### Embodiment 2

20.0 g of the porous capsule prepared by manufacturing example 1, 0.1 ml of triethylamine and 10.0 ml of ethyleneglycol are mixed and agitated for 30 minutes at room temperature. 5.0 ml of isocyanate is dropped to the mixture and the addition polymerization is performed to obtain 30.0 g of capsule coated with polyurethane on the surface of the porous capsule. The above result is put in a molding foam device, and is molded to manufacture a product of the biodegradable polyurethane foam.

The physical properties of the molded products obtained according to the embodiments 1 and 2 are measured and described in following Table 2.

### A Method for Measuring the Physical Properties

Specific gravity: measured according to ASTM D 792.

Biodegradability: measured according to the guide of OECD 301,C,MITI TEST(II)(1992).

Tensile strength: measured according to a test method of ASTM D 412.

Tensile strain: measured according to a test method of ASTM D 412.

TABLE 1

| | | | Tensile | Tensile |
|---|---|---|---|---|
| | Specific | Biodegradability | strength | strain |
| | gravity | (%) | (psi) | (%) |
| Embodiment | 0.04 | 90 | 1.8 | 150 |
| 1 | | | | |
| Embodiment | 0.04 | 89 | 2.1 | 200 |
| 2 | | | | |

Referring to Table 2, the molded products manufactured with the biodegradable polyurethane capsules according to the embodiments 1 and 2 is superior in biodegradability, light in weight and good in physical properties such as tensile strength, etc.

As described above, since the products manufactured by the biodegradable polyurethane capsules can be widely used as heat isolating materials, heat isolating panel, and heat isolating structural materials of such as electric refrigerator, ship and vehicles. Since the biodegradable material inside the capsule is decomposed by microbes in the nature after a certain period, the efficiency of destruction is considerably improved to minimize the conventional problems of soil, air, and sea pollution caused by fill-in or incineration of wastes of the molded foam product.

What is claimed is:

1. A biodegradable polyurethane capsule comprising a powder made from a biodegradable material, first coating layer composed of calcium alginate gel formed on the surface of said powder and second coating layer composed of foamable polyurethane resin formed on the surface of said first coating layer.

2. The biodegradable polyurethane capsule according to claim 1, wherein said powder is made from grain.

3. The biodegradable polyurethane capsule according to claim 2, wherein said grain is corn or foamed corn.

4. A method for manufacturing a biodegradable polyurethane capsule comprising steps of:
a) manufacturing a capsule having first coating layer of calcium alginate gel on the surface of said powder by dropping an aqueous solution of sodium alginate in which a powder made from a biodegradable material is dispersed into a aqueous solution of calcium chloride while agitating;
b) separating and drying said capsule; and
c) forming second coating layer of foamable polyurethane resin on the surface of said separated capsule.

5. The method according to claim 4, wherein said step c) of forming second coating layer of foamable polyurethane resin comprises steps of inputting polyol and isocyanate into said separated capsule and reacting them in the presence of foaming agent and reaction catalyst.

6. The method according to claim 4, wherein said step c) of forming second coating layer of foamable polyurethane resin comprises steps of coating polyol on the surface of said separated capsule and reacting with isocyanate in the presence of foaming agent and reaction catalyst.

7. A biodegradable polyurethane capsule comprising a capsule composed of calcium alginate gel containing carbon dioxide inside the capsule and a coating layer of foamable polyurethane resin formed on the surface of said capsule.

8. A method for manufacturing a biodegradable polyurethane capsule comprising steps of:
a) forming a capsule of calcium alginate gel containing carbon dioxide inside the capsule by dropping a mixed aqueous solution of sodium alginate and sodium bicarbonate into an aqueous solution of calcium chloride while agitating;
d) separating and drying said capsule; and
e) forming a coating layer of foamable polyurethane resin on the surface of the capsule.

9. A biodegradable polyurethane capsule comprising a powder made from the biodegradable material, a coating layer of calcium alginate gel formed on the surface of said powder and an outer layer composed of foamable polyurethane resin prepared by the addition polymerization of activated hydroxide group in calcium alginate gel with isocyanate, which is formed on the surface of said coating layer.

10. A biodegradable polyurethane capsule comprising a capsule of calcium alginate gel containing carbon dioxide inside the capsule and an outer layer composed of foamable polyurethane resin prepared by the addition polymerization of activated hydroxide group in calcium alginate gel with isocyanate, which is formed on the surface of said capsule.
